(19) United States
(12) Patent Application Publication
(10) Pub. No.: US 2021/0345645 A1
(43) Pub. Date: Nov. 11, 2021

(54) FOOD FORMULATIONS AND MANUFACTURING PROCESS THEREOF

(71) Applicant: DILUMIX INDUSTRIAL LTDA., Leme/SP (BR)

(72) Inventors: LUIZ GUILHERME GOBBI MARCONDES, Leme/SP (BR); AULUS CAVALIERI CARCIOFI, Jaboticabal/SP (BR)

(21) Appl. No.: 16/866,582

(22) Filed: May 5, 2020

(51) Int. Cl. A23K 10/30; A23K 10/20; A23K 20/174; A23K 20/158; A23K 20/22; A23K 40/25; A23K 40/10; A23K 50/40; A23K 20/163

(52) U.S. Cl. CPC A23K 10/30; A23K 10/20; A23K 20/174; A23K 20/158; A23K 20/163; A23K 40/25; A23K 40/10; A23K 50/40; A23K 20/22

(57) ABSTRACT

Food formulations and manufacturing process thereof, which introduce food fibers, resulting from residues of other industrial processes, into animal feed. Where these fibers help reduce the apparent digestibility coefficient, conferring a dietary pattern to animal feed, in addition to the manufacturing process of the feed.

### FIELD OF TECHNOLOGY

The following refers to dietary feed formulations for animals, preferably pets, more preferably dogs, containing vegetable fibers obtained from fruits such as guava and/or grasses, such as sugarcane, and grains such as wheat. Additionally, the following reveals a manufacturing process of the aforementioned feed formulations, the process being highly sustainable and capable of producing food with high nutritional value. The following pertains to the field of food engineering, specifically the field of food production specially adapted for animals and the production method thereof.

### BACKGROUND

Plant fibers, also called food fibers, dietary fibers, or simply referred to as fibers, consist of edible parts of plants that are resistant to digestion and absorption by the intestine. Plant fibers are divided into soluble or insoluble in water and may or may not be fermented by the microbiota present in the intestine of mammals.

The fermentation of fibers is related to the speed and extent with which fibers are degraded, resulting in the production of short-chain fatty acids (SCFA), beneficial to the gastrointestinal tract. However, when the concentration of these fatty acids is high, there is an increase in peristalsis, water content in the stool and decreased digestibility of other nutrients. Low fermentation fibers lead to a decrease in dry matter digestibility, besides having low interference in nutrient digestibility in general and stool water content.

Plant fibers consist of the part of vegetables that cannot be attacked by digestive enzymes and have the most diverse compositions, such as cellulose, hemicellulose, pectins and lignins. In general, sources of vegetable fibers are cereals, greens, vegetables and fruits. Plant fibers are beneficial to animals, especially monogastric animals, because they increase the feeling of satiety and bowel mobility, reducing the occurrence of constipation, common in individuals adept at hypocaloric diets.

Traditionally, fibers are classified according to their degree of solubility and viscosity:

Group I—soluble and fermentable fibers;
Group II—soluble and non-fermentable fibers;
Group III—insoluble and fermentable fibers; and
Group IV—insoluble and non-fermentable fibers.

Soluble fibers comprise pectins, gums, mucilages and some hemicellulose, while insoluble fibers comprise cellulose, lignin and some hemicellulose. Fermentable fibers result in high concentrations of short-chain fatty acids, while non-fermentable fatty acids produce little or no amount of these fatty acids. Excessive fiber consumption increases fermentation promoted by bacteria from the intestinal microbiota, which in turn can result in discomfort and intestinal cramps.

Soluble fibers, due to their high water retention capacity, form gels that increase the viscosity of luminal content and interfere in the kinetics of digestion and absorption of nutrients in general. In general, they are usually more rapidly degraded by the intestinal microbiota and result in high concentrations of short-chain fatty acids. Insoluble fibers, in turn, have lower water retention capacity and variable fermentation potential in the intestines of animals, a factor considered in the formulation of the present application.

The function of insoluble fibers in living organisms is quite diverse: while soluble fibers have the characteristic of hindering the transit of molecules within the food cake, exposing some nutrients and aiding their absorption, the insoluble fibers have the function of providing greater consistency to the food cake, since they are a constituent part of the solid portion of the fecal cake, and allow better digestion of nutrients, while limiting the absorption of fats by the body.

The effects of intake of insoluble plant fibers in food have been known since antiquity, with laxative and limiting actions of fat absorption by the intestine (i.e., decreased caloric value of food) the best known and widely disclosed. However, it is possible to assert that few studies are conducted on other possible effects of fibers on humans and animals. From the point of view of food technology, this lack of information has a direct influence on the functional food industry since it limits the possibility of developing foods with high acceptability and low final cost.

A large percentage of pets are overweight or obese. For this reason, the search for healthy eating for pets is frequent on the part of the owners, who also seek to increase longevity and prevent the development of diseases. The inclusion of fibers in the diet has become a reality on the part of the pet food industries: light, diet or reduced calorie versions are now available on the market. Fibers are usually employed to reduce the caloric value of the diet and favor the adjustment between intake versus caloric expenditure, resulting in the maintenance of body condition.

The influence of fibers on nutrient digestibility is established in the Nutrient Requirements of Dogs and Cats. For dogs, each percentage point of fiber added to the food results in a 1.43% decrease in the digestibility of feed energy. Additionally, fibers are included due to the influence on the maintenance of health of the gastrointestinal tract, formation and consistency of feces, reduced appetite, satiety and arguable improvement in carbohydrate metabolism.

The studies available on the use of food fibers in food have been limited to evaluating the inclusion of plant fibers in their industrial form. With the exception of purified cellulose fibers, processing studies of fiber sources themselves, specifically related to the influence of the dimensions of their particles on induced responses in animals, are not available. Consequently, there are no such products available on the consumer market. The industrial processing to which the fiber is submitted, however, alters its physicochemical characteristics and can increase its fermentative potential, its solubility, viscosity, palatability, among other sensory characteristics, which can change the effects of the same.

Domestic animals are usually monogastric and omnivorous animals, i.e. they are endowed with a single stomach and feed on meat and vegetables. The domestication of animals has brought to the fore the concern to meet their food needs with formulations, for example, dry rations, which at the same time are nutritious, easy to manage and low cost, in addition to keeping them healthy. Some formulations also claim to prevent or treat diseases. Properly fed animals have greater longevity and require less medical care, resulting in a consequent decrease in spending by owners.

When animals feed, there is formation of a food cake that runs throughout the gastrointestinal tract and, during this journey, in addition to undergoing the action of several enzymes, is subjected to changes in pH. The apparent digestibility coefficient (ADC) indicates the amount of nutrients actually absorbed in relation to the amount of nutrients ingested at the time of feeding, which is taken into account for the preparation of feed formulation, specifically that of embodiments of the present invention. Dietary formulations should shift this coefficient to lower values, indicating a lower absorption of nutrients, besides taking into account the nutritional need of each phase of animal life. For example, puppies require a greater amount of certain nutrients than adult animals due to their growth, while obese animals should consume more protein than fats. The higher the index of the apparent digestibility coefficient, the better the digestibility.

Obesity, diabetes, hepatitis, heart and kidney failure and pregnancy are some of the conditions that make a radical change in animal eating habits necessary. In these cases, home-cooked food is not recommended, and even prohibited. Other health problems, with lower severity, such as respiratory difficulty, high levels of triglycerides, hypercholesterolemia, hypertension and myalgias may present improvements only with weight reduction, easily achieved, in some cases, with the exchange of conventional feed, for a dietary diet. Thus, the demand for new formulations of low-cost dietary rations, simple manufacturing and high quality is evidenced.

During the industrial processing of guava, up to 47% of guava may be discarded. The residues of this processing, when leaving the industry, generally have high humidity and high concentration of food fibers.

Sugarcane is one of the most cultivated species in the world, mainly for sugar and ethanol production. Through the processes of washing, purification and grinding of sugarcane bagasse, a co-product of the sugar alcohol industry, it is possible to extract sugarcane fiber, composed of 53.5% of cellulose, 31.3% hemicellulose, 6.4% lignin, 2.6% crude protein, 2.6% of matter mineral and unimpressive content of fat. With about 90% of dietary fiber, cane fiber has almost 100% insoluble fiber. The ingredient is practically not fermented by microbiota bacteria and, when added in extruded foods, reduces the digestibility of caloric foods and promotes adequate stool formation.

Wheat bran is one of the main co-products of human feed, obtained from wheat grinding for the production of wheat flour, with wide use in animal feed. This is basically constituted by the pericarp of the wheat seed, where most of its fiber and minerals are concentrated. This ingredient presents between 16 and 19% protein and between 32 and 40% fiber, consisting of 97% of insoluble fiber. Due to its low cost and relative protein content, it is widely used in economical foods. In processes of food manufacturing by extrusion, the inclusion of wheat bran is associated with the reduction of starch cooking in the phase preceding the extrusion per se.

Extrusion comprises a technology widely used for the production of various types of food, both for humans and animals. Humidity, temperature, pressure and grinding are combined, providing great ingredients for mixing, cooking, texturing and food formation in a short time. The widespread use of thermoplastic extrusion in the animal food industry is due to the fact that the technique promotes physical and chemical changes in ingredients, altering their quality of physical properties, which increases its nutritional value in an efficient and inexpensive way.

Among carbohydrates, starch is the main substrate for extrusion to occur properly. During extrusion, starch granules are moistened and receive heat, mechanical friction, pressure and shearing, undergoing the phenomenon of gelatinization: swell, melt and loss of the crystalline structure.

It can be concluded, therefore, that the available methodologies require virgin raw material, i.e. raw material in a natural state. Obtaining these raw materials is responsible for a portion of deforestation, which causes these processes to have negative ecological impact since there is no reuse of waste generated in different industrial processes.

### SUMMARY

An aspect relates to an extruded dietary feed formulation for pets, such as dogs, which contains fibers obtained from fruits, such as guava, and/or grasses, preferably sugarcane and wheat, through an ecologically sustainable process and which results in dietary food of higher quality when compared to other formulations available in the state of the art.

In one form of execution, embodiments of the present invention discloses a feed formulation comprising a source of starch, offal and other animal parts, animal fat, a preparation of vitamins, dietary vegetable fibers, flavoring; sodium chloride; choline chloride; potassium chloride; fish oil, mold inhibitor and antioxidant;

wherein
the source of starch is selected from the group comprising corn grains, cassava flour, lentils, sorghum, wheat and rice;
offal and other pieces of animals may originate from the processing of poultry meats, such as chickens, turkeys, ducks and geese;
animal fat, such as from birds such as chickens, turkeys, ducks and geese;
the preparation of vitamins and minerals comprises vitamins and minerals selected from the group comprising vitamin A, vitamin D, vitamin E, thiamine, riboflavin, pantothenic acid, niacin, pyridoxine, folic acid, vitamin B12, vitamin K, biotin, iron, copper, magnesium, zinc, iodine, selenium and combinations thereof; and
dietary vegetable fibers are selected from the group comprising guava fibers, short sugar cane fibers, long sugar cane fibers, short wheat bran fibers, long wheat bran fibers and combinations thereof.

This formulation can be used in the treatment or prevention of endocrine and metabolic diseases or complications arising from obesity, such as diabetes, arthritis and arthrosis, pancreatitis, orthopedic disorders, cardiovascular diseases, respiratory diseases, dysplasias, liver diseases, gastrointestinal disorders and skin problems.

Embodiments of the present invention also refers to a process for producing the feed formulations in which the sources of plant fibers used were through and chosen in order to meet the demand for ecologically sustainable processes. Therefore, all fibers of plant sources chosen are residues from previous processes, not virgin products. Such waste, from inputs intended for human consumption, if properly processed, add value to the new product.

Accordingly, it is also an aspect of embodiments of the present invention to disclose a process of manufacturing feed, with the addition of food fibers to reduce the Apparent Digestibility Coefficient, comprising the steps of:
(a) weighing;
(b) mixing; and
(c) grinding the ingredients in a hammer mill, with the exception of the sources of dietary vegetable fibers;
(d) crushing and grinding in a roller mill the sources of dietary vegetable fibers to the ideal lengths;
(e) adding and mixing the sources of dietary vegetable fibers to the remainder of the previously ground ingredients;
(f) treating the mixture of dietary ingredients and vegetable fibers with water vapor and water in a preconditioner;
(g) extruding the product in a screw extruder in any desired design for obtaining kibbles;
(h) drying the kibbles obtained in step (g) in a dryer;
(i) coating the kibbles with animal fat and flavoring;
(j) packaging the final product.

### DETAILED DESCRIPTION

Soluble fiber can have high water retention capacity, forming gels that increase the viscosity of luminal content and interfere in the kinetics of digestion and absorption of nutrients present in food. Generally, soluble fiber is more rapidly degraded by the intestinal microbiota, resulting in significant concentrations of short-chain fatty acids. Conversely, insoluble fiber has lower water retention capacity and is hardly fermentable by the microbiota of the intestine of animals. This factor, however, undergoes major variation between the sources of insoluble fibers, being possible to find, within this group, fibers with considerable fermentation capacity, which was studied and considered for the development of the formulation claimed herein.

However, factors related to solubility and fermentation are not sufficient for the characterization of a fiber source as a potential ingredient for the formulation of a dietary feed for animals. The way of obtaining such fibers, their previous processing, form of extraction and grinding and/or crushing should also be considered.

This being the case, the most important characteristics of the fiber source are the dimensions of the fiber, since, in addition to the fiber source used, the effects obtained depend on the particle size of the fiber, as the poor interaction between the fiber source and the organism can cause intestinal discomforts.

In monogastric animals, the inclusion of insoluble vegetable fiber causes a reduction in caloric digestibility, increased production of short-chain fatty acids and moisture from feces. Due to its low production cost and relative protein content, plant fibers can be used on a large scale for the production of functional foods without increasing their final value. The vegetable fiber relates to the formation of extrudates that are rigid and coarse in aspect, but such characteristics have been minimized or reversed in embodiments of the present invention by adequacy of the size of the fiber particle to be mixed with other ingredients. Put otherwise, the efficiency of the production process of dietary formulation for animals, from sources of plant fibers previously processed is directly related to the grinding efficiency of this source of fibers in fiber particles.

Considering the above description, the inventors observed that very fine grinding of the vegetable fiber may alter the functional properties of these raw materials, and that the use of smaller fibers generates less interference in the extrusion and cooking process of the feed formulation.

In accordance with the objectives presented, this patent application presents a “FEED FORMULATION” comprising a source of starch, offal and other animal parts, animal fat, a preparation of vitamins, dietary plant fibers, flavoring; sodium chloride; choline chloride; potassium chloride; fish oil, mold inhibitor and antioxidant;
wherein
the source of starch is selected from the group comprising corn grains, cassava flour, lentils, sorghum, wheat and rice;
offal and other animal parts originate from the processing of poultry meats, such as chickens, turkeys, ducks and geese;
animal fat, such as from birds such as chickens, turkeys, ducks and geese;
the preparation of vitamins and minerals comprises vitamins and minerals selected from the group comprising vitamin A, vitamin D, vitamin E, thiamine, riboflavin, pantothenic acid, niacin, pyridoxine, folic acid, vitamin B12, vitamin K, biotin, iron, copper, magnesium, zinc, iodine, selenium and combinations thereof; and
dietary vegetable fibers are selected from the group comprising guava fibers, short sugar cane fibers, long sugar cane fibers, short wheat bran fibers, long wheat bran fibers and combinations thereof.

In embodiments of the formulation of the present invention, the source of starch comprises between 20 and 60% by weight of the formulation of feed, the offal and other animal parts comprise between 25 and 35% by weight of the feed formulation, the animal fat comprises between 5 and 10% by weight of the formulation, the vitamin preparation comprises between 0.1 and 1.5% by weight of the feed formulation, the flavoring comprises between 1 and 3% by weight of the feed formulation, the sodium chloride comprises between 0.3 and 1.5% by weight of the formulation of the diet, the choline chloride comprises between 0.1 and 1.5% by weight of feed formulation, the potassium chloride comprises between 0.1 and 1.5% by weight of feed formulation, the fish oil comprises between 0.05 and 1% by weight of feed formulation, the mold inhibitor comprises between 0.01 and 1% by weight of the feed formulation and antioxidant comprises between 0.01 and 1% by weight of the feed formulation.

The formulation of embodiments of the present invention uses two types of fibers for each source of food fiber used, differentiated by its length. Therefore, throughout this specification the fibers will be referred to as “short fibers” and “long fibers”. The short fibers were obtained using roller mills equipped with sieve having a mesh opening of 250 μm. Long fibers were obtained using roller mills equipped with sieve having a mesh opening of 500 μm.

The method used in embodiments of the present invention to reduce the particle size of vegetable fibers was grinding with roller mill, which provides a more uniform texture product. Two or more heavy cylinders rotate in opposite directions, at equal speeds or otherwise. The feeding of the equipment is done on its top and the particles are compressed between the rollers, which have longitudinal grooves that promote the cutting of the material, which is subjected to compression forces. The distance between the rollers is adjustable, which determines the final size of the particles produced.

In embodiments of the present invention, when the dietary fiber is guava, the fibers comprise between 1 and 15% by weight of the formulation of the diet and are between 130 and 296 μm in length. Alternatively, when the dietary fiber is sugar cane, short or long, the fibers comprise between 5 and 15% by weight of the formulation, and the short fibers are between 7 and 385 μm in length; and long fibers are between 76 and 712 μm in length. Alternatively, when the dietary fiber is wheat bran, short or long, the fibers comprise between 20 and 40% by weight of the formulation, and the short fibers are between 41 and 245 μm in length; and long wheat bran fibers are between 103 and 587 μm in length.

In an embodiment of the present invention, dietary plant fibers have less than 3% of soluble fiber and more than 30% of insoluble fiber in their composition.

Embodiments of the present invention also introduces a set of formulations as embodiments of the formulation claimed. The first embodiment is a formulation comprising corn grains, viscera flour, sugar cane insoluble fiber, rice grits, chicken oil, palatabilizer, vitamin and mineral preparation, sodium chloride and limestone, in which corn grains are present in an amount between 43 and 53%, viscera flour is present in an amount between 28 and 34%, sugarcane is present in an amount between 5 and 15%, rice grits are present in an amount between 2 and 8%, chicken oil is present in an amount between 0.5 and 3.5%, the palatabilizer is present in an amount between 0.5 and 1.5%, the preparation of vitamins is present between 0.25 and 0.75%, sodium chloride is present in an amount between 0.15 and 0.50% and limestone is present in an amount between 0.1 and 0.4%, all percentages being by weight of the feed formulation.

Further according to this first embodiment, the formulation comprises between 53% and 73% corn grains; between 12% and 32% of viscera flour, between 1.5% and 5% sugarcane fiber, between 2% and 8% rice grits; between 2% and 5% chicken oil; between 0.5% and 1.5% palatabilizer; between 0.25% and 0.75% of vitamin and mineral preparation; between 0.15% and 0.50% sodium chloride and between 0.5% and 0.7% of limestone, all percentages being by weight of the feed formulation.

The second embodiment is a formulation comprising corn grains, viscera flour, sugar cane insoluble fiber, rice grits, chicken oil, palatabilizer, vitamin and mineral preparation, sodium chloride and corn protein, wherein the corn grains are present in an amount between 35 and 55%, viscera flour is present in an amount between 22 and 42%, sugarcane fiber is present in an amount between 3 and 7%, rice grits are present in an amount between 3 and 6%, chicken oil is present in an amount between 1 and 3%, the palatabilizer is present in an amount between 0.5 and 1.5%, the preparation of vitamins and minerals is present in an amount between 0.25 and 0.75%, sodium chloride is present in an amount between 0.15 and 0.50% and corn protein is present in an amount between 5 and 11%, all percentages being by weight of the feed formulation.

Also according to this second embodiment of the present invention, the formulation comprises between 28% and 48% corn grains, between 22% and 42% of viscera flour; between 3% and 7% sugarcane fiber, between 7% and 12% of rice grits, between 2% and 4% chicken oil; between 0.5% and 1.5% of palatabilizer, between 0.25% and 0.75% of vitamin and mineral preparation, between 0.15% and 0.50% sodium chloride and between 5% and 11% corn protein, all percentages being by weight of the feed formulation.

A second aspect of embodiments of the present invention is a process for manufacturing feed with the addition of food fibers to reduce the apparent digestibility coefficient that comprises the steps of:
(a) weighing;
(b) mixing; and
(c) grinding the ingredients in a hammer mill, with the exception of the sources of dietary vegetable fibers;
(d) crushing and grinding in a roller mill the sources of dietary vegetable fibers to the ideal lengths;
(e) adding and mixing the sources of dietary vegetable fibers to the rest of the previously ground ingredients;
(f) treating the mixture of ingredients and dietary vegetable fibers with water vapor and water in a preconditioner;
(g) extruding the product in a screw extruder in any desired design for obtaining kibbles;
(h) drying the kibbles obtained in step (g) in a dryer;
(i) coating the kibbles with animal fat and flavoring; and
(j) packaging the final product.

In embodiments of the process of the present invention, the treatment of ingredients and dietary vegetable fibers is carried out in a step prior to the extrusion per se, with residence time between 2 and 10 minutes and temperature between 75 and 100° C.

In the process claimed, the step (g) of extruding the product in a screw extruder in any desired design for obtaining kibbles occurs under the following conditions:
(a) Extruder screw rotation speed may be defined between 400 and 600 rpm;
(b) Extrusion mold temperature may be established between 100 and 150° C.; and
(c) Extrusion mold pressure may be established between 50 and 80 bar.

In one last embodiment of the process, drying occurs between 100 and 110° C. in an interval between 20 and 40 minutes.

Through the application of the process disclosed herein, there is a lower consumption of electricity during the processing and formation of extrudates with better macrostructure. The best macrostructure of extruded favors the acceptance and palatability of food, and the reduction of the fiber particle size can also alter the microbial degradation of the products, increasing their fermentation and altering their influence on the digestibility, retention time and stool formation.

In addition, it was observed that embodiments of the present invention reduces the levels of apparent digestibility coefficient in relation to conventional formulations produced without the addition of fibers. Thus, embodiments of the invention satisfactorily fulfills the objective of introducing a feed formulation suitable for treating or preventing endocrine and metabolic diseases, or complications arising from obesity, such as diabetes, arthritis and arthrosis, pancreatitis, orthopedic disorders, cardiovascular diseases, respiratory diseases, dysplasias, liver diseases, gastrointestinal disorders and skin problems. Coefficient levels for various nutrients are presented in detail in the examples below.

### EXAMPLES

Through the process reported in embodiments of the present invention, a variety of feed formulations for dogs was manufactured, identified as:
CO: control, feed manufactured without the addition of fibers;
GF3: feed manufactured with the addition of 3% of guava fibers;
GF6: feed manufactured with the addition of 6% of guava fibers;
GF12: feed manufactured with the addition of 12% of guava fibers;
SCS: feed manufactured with the addition of short fibers of sugar cane;
SCL: feed manufactured with the addition of long fibers of sugar cane;
WBS: feed manufactured with the addition of short fibers of wheat bran; and
WBL: feed manufactured with the addition of long fibers of wheat bran.

The list of ingredients, chemical composition, degree of starch gelatinization (GGA) of the CO, GF3, GF6 and GF12 feeds are set out in Table 1 below:

TABLE 1
LIST OF INGREDIENTS, CHEMICAL COMPOSITION
AND GGA OF THE FEEDS CO, GF3, GF6 AND GF12

| | Feed | | | |
|---|---|---|---|---|
| Item | CO | GF3 | GF6 | GF12 |

Ingredients (% by weight)

| | | | | |
|---|---|---|---|---|
| Corn Grains | 57.82 | 54.68 | 51.64 | 44.94 |
| Offal and other poultry | 31.80 | 31.86 | 31.82 | 32.52 |
| parts | | | | |
| Guava fiber | — | 3.00 | 6.00 | 12.00 |
| Poultry fat | 6.44 | 6.52 | 6.60 | 6.60 |
| Flavoring | 2.00 | 2.00 | 2.00 | 2.00 |
| Sodium chloride | 0.50 | 0.50 | 0.50 | 0.50 |
| Choline chloride | 0.20 | 0.20 | 0.20 | 0.20 |
| Potassium chloride | 0.65 | 0.65 | 0.65 | 0.65 |
| Preparation of vitamins | 0.30 | 0.30 | 0.30 | 0.30 |
| and minerals | | | | |
| Fish oil | 0.15 | 0.15 | 0.15 | 0.15 |
| Mold inhibitor | 0.10 | 0.10 | 0.10 | 0.10 |
| Antioxidant | 0.04 | 0.04 | 0.04 | 0.04 |
| Total | 100 | 100 | 100 | 100 |

Chemical composition (% by weight)

| | | | | |
|---|---|---|---|---|
| Moisture | 5.90 | 6.80 | 6.00 | 7.30 |
| Ashes | 6.00 | 5.57 | 6.62 | 6.10 |
| Proteins | 25.21 | 25.77 | 25.95 | 25.17 |
| Fat | 15.30 | 15.90 | 15.20 | 14.61 |
| Starch | 41.20 | 38.70 | 35.70 | 36.08 |
| Food fibers, of which: | 10.75 | 13.13 | 16.63 | 18.36 |
| Insoluble fibers | 10.75 | 12.85 | 16.37 | 17.69 |
| Soluble fibers | 0.00 | 0.28 | 0.26 | 0.67 |
| GGA (%) | 92.82 | 91.04 | 90.50 | 88.33 |

The list of ingredients, chemical composition, degree of starch gelatinization (GGA) of the feeds SCS, SCL, WBS and WBL are set out in Table 2 below:

TABLE 2
LIST OF INGREDIENTS, CHEMICAL COMPOSITION
AND GGA OF THE FEEDS SCS, SCL, WBS AND WBL

| | Feed | | | |
|---|---|---|---|---|
| Item | SCS | SCL | WBS | WBL |

Ingredients (%)

| | | | | |
|---|---|---|---|---|
| Corn Grains | 45.89 | 45.89 | 30.30 | 30.30 |
| Offal and other poultry | 32.17 | 32.17 | 26.12 | 26.12 |
| parts | | | | |
| Short fibers of sugar | 9.00 | — | — | — |
| cane | | | | |
| Long fibers of sugar | — | 9.00 | — | — |
| cane | | | | |
| Short fibers of wheat | — | — | 32.00 | — |
| bran | | | | |
| Long fibers of wheat | — | — | — | 32.00 |
| bran | | | | |
| Poultry fat | 9.00 | 9.00 | 7.64 | 7.64 |
| Flavoring | 2.00 | 2.00 | 2.00 | 2.00 |
| Sodium chloride | 0.50 | 0.50 | 0.50 | 0.50 |
| Choline chloride | 0.20 | 0.20 | 0.20 | 0.20 |
| Potassium chloride | 0.65 | 0.65 | 0.65 | 0.65 |
| Preparation of vitamins | 0.30 | 0.30 | 0.30 | 0.30 |
| and minerals | | | | |
| Fish oil | 0.15 | 0.15 | 0.15 | 0.15 |
| Mold inhibitor | 0.10 | 0.10 | 0.10 | 0.10 |
| Antioxidant | 0.04 | 0.04 | 0.04 | 0.04 |
| Total | 100 | 100 | 100 | 100 |

Chemical composition (%)

| | | | | |
|---|---|---|---|---|
| Moisture | 6.19 | 5.40 | 6.42 | 5.30 |
| Ashes | 5.87 | 5.48 | 6.06 | 6.14 |
| Proteins | 25.88 | 25.07 | 25.40 | 25.01 |
| Fat | 14.71 | 15.03 | 15.56 | 14.48 |
| Starch | 38.00 | 37.82 | 34.54 | 34.26 |
| Food fibers, of which | 16.75 | 16.47 | 17.99 | 18.01 |
| Insoluble fibers | 16.75 | 16.47 | 17.11 | 17.22 |
| Soluble fibers | 0.0 | 0.0 | 0.88 | 0.79 |
| GGA (%) | 94.56 | 93.77 | 94.01 | 91.93 |

Table 3 below presents the levels of Apparent Digestibility Coefficient for various nutrients in relation to the formulations CO, GF3, GF6 and GF12.

TABLE 3
LEVELS OF APPARENT DIGESTIBILITY COEFFICIENT
FOR VARIOUS NUTRIENTS IN RELATION TO THE
FORMULATIONS CO, GF3, GF6 AND GF12

Feed

| | | | | |
|---|---|---|---|---|
| Item | CO | GF3 | GF6 | GF12 |

CDA (%)

| | | | | |
|---|---|---|---|---|
| Dry matter | 80.8 | 82.6 | 77.7 | 74.5 |
| Organic matter | 84.0 | 85.6 | 81.0 | 77.0 |
| Proteins | 82.5 | 83.8 | 82.0 | 79.0 |
| Hydrolyzable fat | 89.5 | 92.6 | 88.5 | 88.7 |
| Food fibers | 23.0 | 38.7 | 38.2 | 24.5 |
| Starch | 99.7 | 99.7 | 99.7 | 99.7 |
| Raw energy | 84.5 | 85.8 | 82.3 | 77.8 |

Lastly, Table 4 presents the levels of Apparent Digestibility Coefficient for various nutrients in relation to the formulations CO, SCS, SCL, WBS and WBL.

TABLE 4
LEVELS OF APPARENT DIGESTIBILITY COEFFICIENT
FOR VARIOUS NUTRIENTS OF THE FORMULATIONS
CO, SCS, SCL, WBS AND WBL.

| | Feed | | | | |
|---|---|---|---|---|---|
| Item | CO | SCS | SCL | WBS | WBL |

CDA (%)

| | | | | | |
|---|---|---|---|---|---|
| Dry matter | 80.8 | 74.7 | 77.2 | 75.3 | 73.4 |
| Organic matter | 84.0 | 77.3 | 79.7 | 77.7 | 75.6 |
| Proteins | 82.5 | 80.8 | 83.2 | 80.7 | 78.8 |
| Hydrolyzable fat | 89.5 | 90.9 | 90.5 | 91.4 | 89.2 |
| Food fibers | 23.0 | 17.6 | 24.1 | 30.4 | 24.1 |
| Starch | 99.7 | 99.7 | 99.6 | 99.7 | 99.6 |
| Raw energy | 84.5 | 78.2 | 80.3 | 77.9 | 75.8 |

As examples of simplified formulations, feeds were produced with addition of fibers of sugar cane, with any proportion of long or short fibers, being between 7 μm and 712 μm in length. The formulations were identified as:
SSC-I: feed manufactured with the addition of 5 to 15% of sugar cane fibers;
SSC-II: feed manufactured with the addition of 1.5 to 5% of sugar cane fibers;
SSC-III: feed manufactured with the addition of 3 to 7% of sugar cane fibers; and
SSC-IV: feed manufactured with the addition of 3 to 7% of sugar cane fibers.

Table 5 below presents the list of ingredients, with the percentage ranges by weight, of the feeds SSC-I, SSC-II, SSC-III and SSC-IV.

TABLE 5
LIST OF INGREDIENTS OF THE FEEDS
SSC-I, SSC-II, SSC-III AND SSC-IV

| | Feed | | | |
|---|---|---|---|---|
| Item | SSC-I | SSC-II | SSC-III | SSC-IV |
| Corn Grains | 43 to 53 | 53 to 73 | 35 to 55 | 28 to 48 |
| Sugar cane | 5 to 15 | 1.5 to 5 | 3 to 7 | 3 to 7 |
| fiber | | | | |
| Rice grits | 2 to 8 | 2 to 8 | 3 to 6 | 7 to 12 |
| Chicken oil | 0.5 to 3.5 | 2 to 5 | 1 to 3 | 2 to 4 |
| Palatabilizer | 0.5 to 1.5 | 0.5 to 1.5 | 0.5 to 1.5 | 0.5 to 1.5 |
| Preparation of | 0.25 to 0.75 | 0.25 to 0.75 | 0.25 to 0.75 | 0.25 to 0.75 |
| vitamins and | | | | |
| minerals | | | | |
| Sodium | 0.15 to 0.5 | 0.15 to 0.5 | 0.15 to 0.5 | 0.15 to 0.5 |
| chloride | | | | |
| Limestone | 0.1 to 0.4 | 0.5 to 0.7 | — | — |
| Corn Protein | — | — | 5 to 11 | 5 to 11 |

It should be understood that this description does not limit the application to the details described herein and that embodiments of the invention is capable of other modalities and of being practiced or carried out in a variety of modes, within the scope of the claims. Although specific terms have been used, the terms should be interpreted in a generic and descriptive sense, and not for the purpose of limitation.

1. A feed formulation, comprising a source of starch, offal and other animal parts, animal fat, a preparation of vitamins, dietary vegetable fibers, flavoring; sodium chloride; choline chloride;
potassium chloride; fish oil, mold inhibitor and antioxidant;
wherein
the source of starch is selected from the group that comprises corn grains, cassava flour, lentils, sorghum, wheat and rice;
the offal and other animal parts originate from the processing of poultry meats;
animal fat, originating from poultry;
the preparation of vitamins and minerals includes vitamins and minerals selected from the group comprising vitamin A, vitamin D, vitamin E, thiamine, riboflavin, pantothenic acid, niacin, pyridoxine, folic acid, vitamin B 12, vitamin K, biotin, iron, copper, magnesium, zinc, iodine, selenium and combinations thereof; and
the dietary vegetable fibers are selected from the group that comprises guava fibers, short fibers of sugar cane, long fibers of sugar cane, short fibers of wheat bran, long fibers of wheat bran and combinations thereof.

2. The feed formulation according to claim 1, wherein the source of starch comprises between 20 and 60% by weight of the feed formulation, the offal and other animal parts comprise between 25 and 35% by weight of the feed formulation, the animal fat comprises between 5 and 10% by weight of the formulation, the preparation of vitamins comprises between 0.1 and 1.5% by weight of the feed formulation, the flavoring comprises between 1 and 3% by weight of the feed formulation, the sodium chloride comprises between 0.3 and 1.5% by weight of the feed formulation, the choline chloride comprises between 0.1 and 1.5% by weight of the feed formulation, the potassium chloride comprises between 0.1 and 1.5% by weight of the feed formulation, the fish oil comprises between 0.05 and 1% by weight of the feed formulation; the mold inhibitor comprises between 0.01 and 1% by weight of the feed formulation and the antioxidant comprises between 0.01 and 1% by weight of the feed formulation.

3. The feed formulation according to claim 1, wherein when the dietary fiber is guava, the fibers comprise between 2 and 15% by weight of the feed formulation.

4. The feed formulation according to claim 3, wherein the guava fibers are between 130 and 296 μm in length.

5. The feed formulation according to claim 1, wherein when the dietary fiber is sugar cane, short or long, the fibers comprise between 5 and 15% by weight of the formulation.

6. The feed formulation according to claim 5, wherein the short fibers of sugar cane are between 7 and 385 μm in length; and the long fibers of sugar cane are between 76 and 712 μm in length.

7. The feed formulation according to claim 1, wherein when the dietary fiber is wheat bran, short or long, the fibers comprise between 20 and 40% by weight of the feed formulation.

8. The feed formulation according to claim 7, wherein the short fibers of wheat bran are between 41 and 245 μm in length; and the long fibers of wheat bran are between 103 and 587 μm in length.

9. The feed formulation, according to claim 1, wherein the dietary vegetable fibers present less than 3% of soluble fiber and more than 30% of insoluble fiber in their composition.

10. The feed formulation comprising corn grains, viscera flour, insoluble fiber of sugar cane, rice grits, chicken oil, palatabilizer, preparation of vitamins and minerals, sodium chloride and limestone.

11. The feed formulation according to claim 10, comprising between 43% and 53% of corn grains, between 28% and 34% of viscera flour, between 5% and 15% sugar cane fiber; between 2% and 8% of rice grits; between 0.5% and 3.5% of chicken oil; between 0.5% and 1.5% of palatabilizer; between 0.25% and 0.75% of preparation of vitamins and minerals; between 0.15% and 0.50% of sodium chloride and 0.1% to 0.4% of limestone, all percentages being by weight of the feed formulation.

12. The feed formulation according to claim 11, comprising between 53% and 73% of corn grains; between 12% and 32% of viscera flour, between 1.5% to 5% of sugar cane fiber, between 2% and 8% of rice grits; between 2% and 5% of chicken oil; between 0.5% and 1.5% of palatabilizer; between 0.25% and 0.75% of preparation of vitamins and minerals; between 0.15% and 0.50% of sodium chloride and between 0.5% and 0.7% of limestone, all percentages being by weight of the feed formulation.

13. The feed formulation comprising corn grains, viscera flour, insoluble fiber of sugar cane, rice grits, chicken oil, palatabilizer, preparation of vitamins and minerals, sodium chloride and corn protein.

14. The feed formulation according to claim 13, comprising between 35% and 55% of corn grains, between 22% and 42% of viscera flour, between 3% and 7% of sugar cane fiber; between 3% and 6% of rice grits, between 1% and 3% of chicken oil, between 0.5% and 1.5% palatabilizer, between 0.25% and 0.75% of preparation of vitamins and minerals, between 0.15% and 0.50% of sodium chloride; and between 5% and 11% of corn protein, all percentages being by weight of the feed formulation.

15. The feed formulation according to claim 13, comprising between 28% and 48% of corn grains, between 22% and 42% of viscera flour; between 3% and 7% of sugar cane fiber, between 7% and 12% of rice grits, between 2% and 4% of chicken oil; between 0.5% and 1.5% of palatabilizer, between 0.25% and 0.75% of preparation of vitamins and minerals, between 0.15% and 0.50% of sodium chloride and between 5% and 11% corn protein, all percentages being by weight of the feed formulation.

16. A process for manufacturing feed with addition of food fibers to reduce the Apparent Digestibility Coefficient, comprising the steps of:
(k) weighing;
(l) mixing; and
(m) grinding the ingredients in a hammer mill, with the exception of the sources of dietary vegetable fibers;
(n) crushing and grinding in a roller mill the sources of dietary vegetable fibers to the ideal lengths;
(o) adding and mixing the sources of dietary vegetable fibers to the remainder of the previously ground ingredients;
(p) treating the mixture of ingredients and dietary vegetable fibers with water vapor and water in a preconditioner;
(q) extruding the product in a screw extruder in any desired design for obtaining kibbles;
(r) drying the kibbles obtained in step (g) in a dryer;
(s) coating the kibbles with animal fat and flavoring; and
(t) packaging the final product.

17. The process, according to claim 16, wherein the treatment of the ingredients and dietary vegetable fibers is carried out in a step prior to the extrusion per se, with residence time between 2 and 10 minutes and temperature between 75 and 100° C.

18. The process, according to claim 16, wherein the step (g) of extruding the product in a screw extruder in any desired design for obtaining kibbles occurs under the following conditions:
(a) extruder screw rotation speed may be defined between 400 and 600 rpm;
(b) extrusion mold temperature may be established between 100 and 150° C.; and
(c) extrusion soft pressure may be established between 50 and 80 bar.

19. The process according to claim 16, wherein the drying occurs between 100 and 110° C. at an interval between 20 and 40 minutes.
